(19) United States
(12) Patent Application Publication
(10) Pub. No.: US 2016/0081779 A1
(43) Pub. Date: Mar. 24, 2016

(54) Solar powered dental hygiene device

(71) Applicant: Wan-Chih LIANG, Taiwan (CN)

(72) Inventor: Hsin-Chen Lin, Kaohsiung (TW)

(21) Appl. No.: 14/892,692

(22) PCT Filed: Jun. 21, 2013
(86) PCT No.: PCT/CN2013/077648

§ 371 Date: Nov. 20, 2015

(30) Foreign Application Priority Data
May 24, 2013 (CN) 201310197198.2

(51) Int. Cl. A61C 17/22; A46B 13/02; H02S 10/20; A46B 5/00

(52) U.S. Cl. CPC A61C 17/224; A61C 17/227; A61C 17/225; A46B 5/0095; A46B 13/02; H02S 10/20

(57) ABSTRACT

A solar powered dental hygiene device is described and includes a hollow handle including a switch disposed an outer surface; a cleaning assembly including a head, a brush type cleaning unit rotatably disposed on the head, and a neck extending out of the head and configured to releasably secure to the handle; a solar module disposed on the outer surface of the handle and configured to generate electrical power in response to light; a rechargeable battery disposed in the handle and configured to store the electrical power wherein the rechargeable battery is electrically connected to the switch; a drive source disposed in the handle and electrically connected to the rechargeable battery; and a rotation member disposed in the handle and electrically connected to the drive source. The cleaning unit is configured to rotate in response to an activation of the rotation member.

### BACKGROUND OF THE INVENTION

1. Field of the Invention

The invention relates to toothbrush and more particularly to a solar powered dental hygiene device.

2. Description of Related Art

Toothbrush is an oral hygiene instrument used to clean the teeth and gums. Typically, the toothbrush includes a head having a plurality of tightly clustered bristles mounted thereon, and a handle adapted to grasp by a user.

It has been discovered that compared to a manual brush, a power (e.g., electric) brush does the better job in reducing gingivitis and plaque. An electric toothbrush, driven by a motor, performs oscillations or rotations of its bristles. It cleans hard to reach places. Further, the electric version can be more comfortable.

However, quick consumption of electricity of the electric toothbrush and a subsequent charging thereof make it bothersome to individuals often using it.

Thus, the need for improvement still exists.

### SUMMARY OF THE INVENTION

It is therefore one object of the invention to provide a dental hygiene device comprising a hollow handle including an on/off switch mounted an outer surface; a cleaning assembly including a head, a cleaning unit rotatably mounted on the head, and a neck extending out of the head and configured to releasably secure to the handle; a solar module mounted on the outer surface of the handle and configured to generate electrical power in response to light; a rechargeable battery mounted in the handle and configured to store the electrical power wherein the rechargeable battery is electrically connected to the on/off switch; a drive source mounted in the handle and electrically connected to the rechargeable battery; and a rotation member mounted in the handle and electrically connected to the drive source; wherein the cleaning unit is configured to rotate in response to an activation of the rotation member.

Preferably, the cleaning unit is a plurality of bristles.

Preferably, the cleaning unit is an interdental brush.

Preferably, the handle further comprises two through holes at a first end, the rechargeable battery comprises two sockets aligned with the through holes.

It is another object of the invention to provide a dental hygiene device comprising a hollow handle including an on/off switch mounted an outer surface; a cleaning assembly including a head, a cleaning unit mounted on the head, a neck extending out of the head and configured to releasably secure to the handle, and a tube through the neck to connect to the cleaning unit; a solar module mounted on the outer surface of the handle and configured to generate electrical power in response to light; a rechargeable battery mounted in the handle and configured to store the electrical power wherein the rechargeable battery is electrically connected to the on/off switch; a drive source mounted in the handle and electrically connected to the rechargeable battery; a reservoir mounted in the handle; and a pump mounted in the handle; wherein the pump is configure to move water from the reservoir to the cleaning unit through the tube in response to an activation of the drive source.

Preferably, the cleaning unit is a plurality of bristles.

Preferably, the cleaning unit is an interdental brush.

Preferably, the cleaning unit is a nozzle.

Preferably, the cleaning unit is a concentric nozzle.

Preferably, the handle further comprises two through holes at a first end, the rechargeable battery comprises two sockets aligned with the through holes.

The above and other objects, features and advantages of the invention will become apparent from the following detailed description taken with the accompanying drawings.

### BRIEF DESCRIPTION OF THE DRAWINGS

FIG. 1 is a perspective view of a solar powered dental hygiene device according to a first preferred embodiment of the invention;

FIG. 2 is a longitudinal sectional view of handle and neck of the dental hygiene device with the solar module detached;

FIG. 3 is a view similar to FIG. 2 with the neck further detached and showing the cylindrical brush replaced by an interdental brush;

FIG. 4 is a longitudinal sectional of a solar powered dental hygiene device according to a second preferred embodiment of the invention, the neck being detached from the handle;

FIG. 5 is a view similar to FIG. 4 with the neck and the handle being assembled;

FIG. 5A is a detailed view of the area of circle A in FIG. 5; and

FIG. 6 is a view similar to FIG. 4 showing another configuration of the cleaning head.

### DETAILED DESCRIPTION OF THE INVENTION

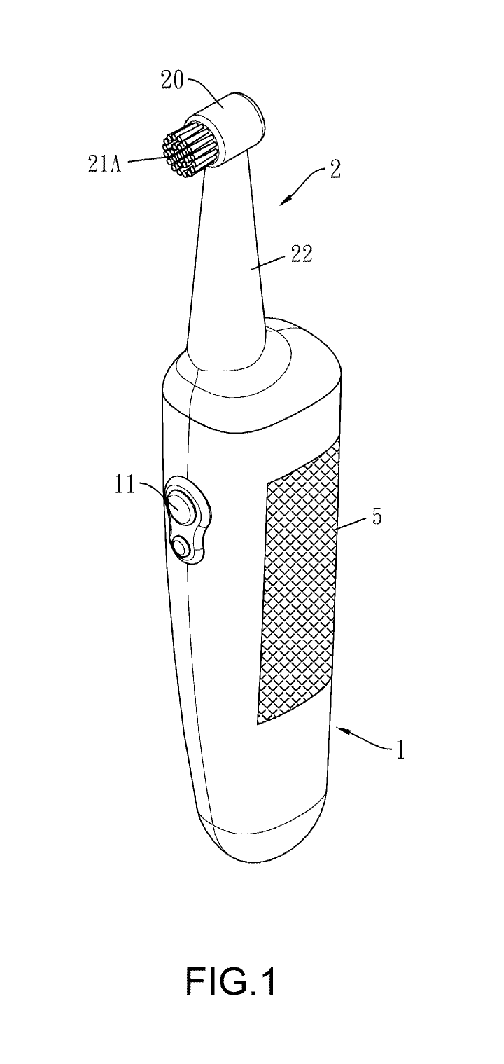

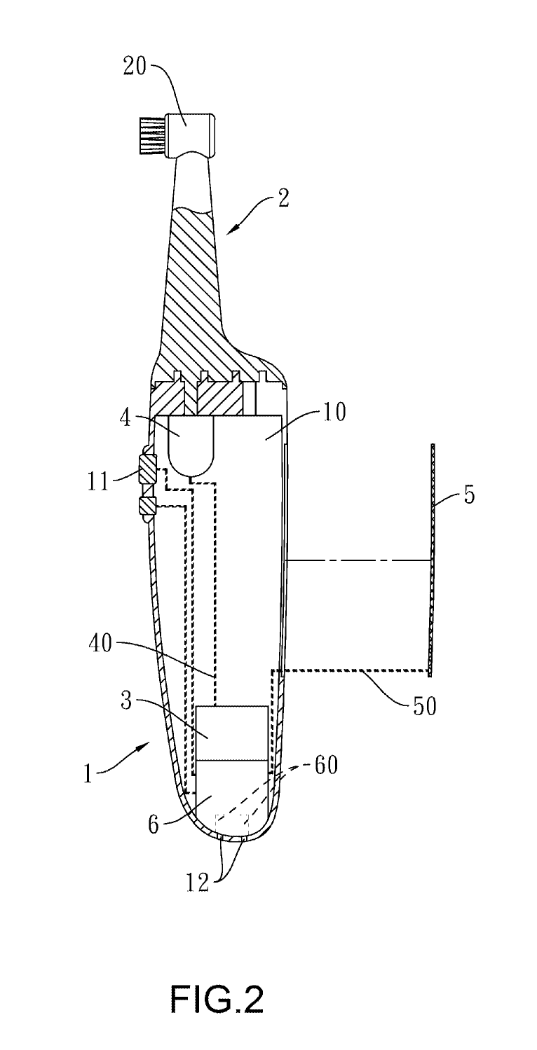

Referring to FIGS. 1 and 2, a solar powered dental hygiene device in accordance with a first preferred embodiment of the invention comprises the following components as discussed in detail below.

A handle 1 includes an internal space 10, an on/off switch 11 mounted an outer surface, two through holes 12 on a bottom, and a complimentary connection portion 13 at a top end; a cleaning assembly 2 includes a head 20, a plurality of bristles 21A rotatably mounted on the head 20, a neck 22 extending out of the head 20, and a corresponding complimentary connection portion 23 at an end of the neck 22 and configured to releasably secure to the complimentary connection portion 13; a solar module 5 mounted on the outer surface of the handle 1 and configured to generate electrical power in response to light; a rechargeable power source (e.g., rechargeable battery) 6 mounted on a bottom of the space 10 and configured to store the electrical power generated by the solar module 5 by means of an interconnection wiring 50, the rechargeable power source 6 being further electrically connected to the on/off switch 11 and having two sockets 60 aligned with the through holes 12; a drive source (e.g., motor) 3 mounted on the rechargeable power source 6 and electrically connected thereto; and a rotation member 4 mounted adjacent to the complimentary connection portion 13 and electrically connected to the drive source 3 by means of an interconnection wiring 40.

In a tooth cleaning operation, a user may turn on the on/off switch 11 to activate the drive source 3. And in turn, the rotation member 4 is activated to rotate the bristles 21A to clean teeth.

The user may attach a plug, connected to a mains electric power, to the sockets 60 by inserting through the through holes 12 if the rechargeable power source 6 is consumed and a quick charging of the rechargeable power source 6 is desired.

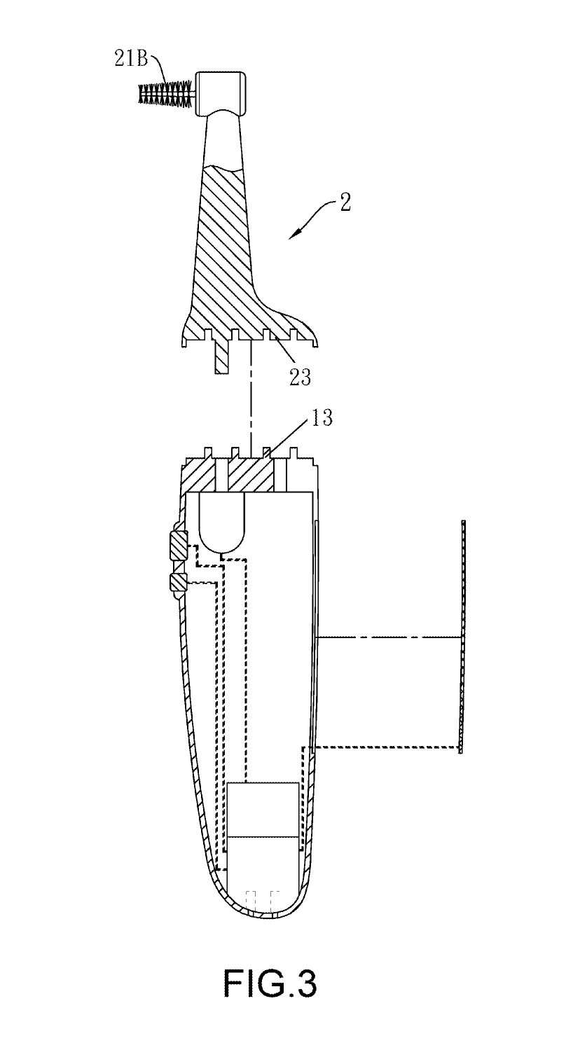

Referring to FIG. 3, the cleaning assembly 2 having a cylindrical brush 21A shown in FIGS. 1 and 2 can be replaced by an interdental brush 21B if such need is desired.

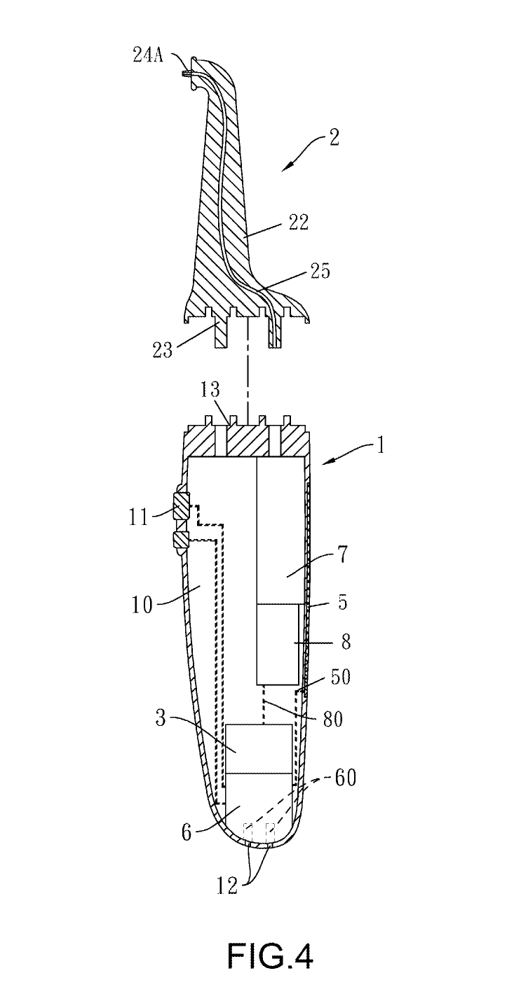

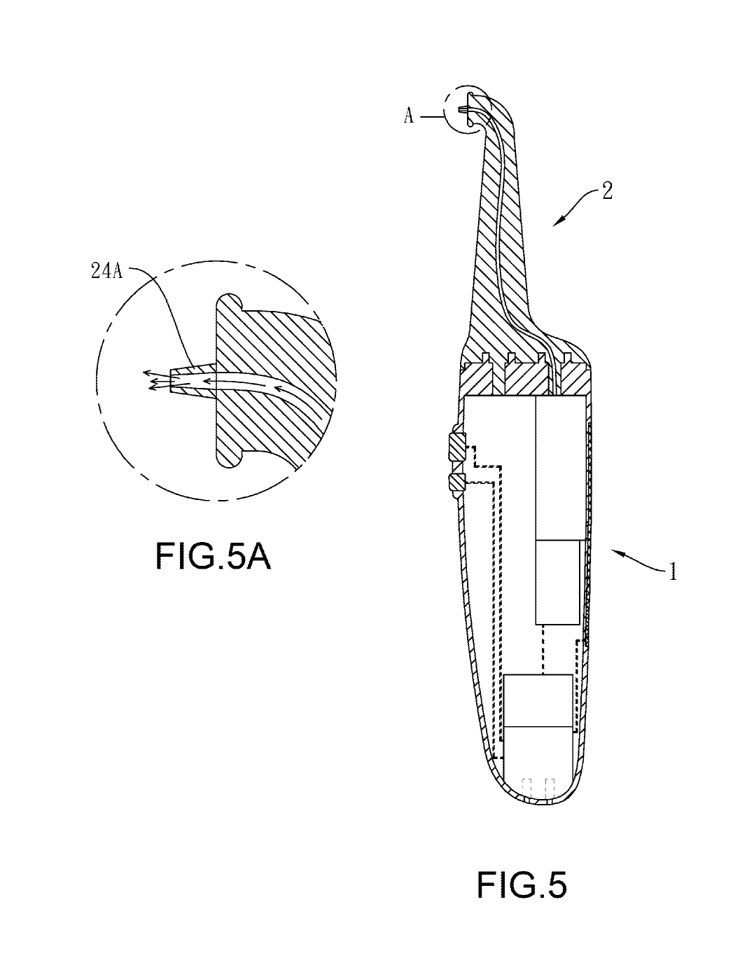

Referring to FIGS. 4 and 5, a solar powered dental hygiene device in accordance with a second preferred embodiment of the invention is shown. The characteristics of the second preferred embodiment are substantially the same as that of the first preferred embodiment except the following:

The rotation member 4 and the interconnection wiring 40 are eliminated. A reservoir 7 filled with water is provided in the space 10, and a pump 8 is provided under the reservoir 7. The pump 8 is electrically connected to the drive source 3 by means of an interconnection wiring 80 so that it can be activated by the drive source 3. The activated pump 8 can move fluid to a nozzle 24A through a tube 25 extending from the corresponding complimentary connection portion 23 to the nozzle 24A. Finally, the high pressure water is ejected from the nozzle 24A.

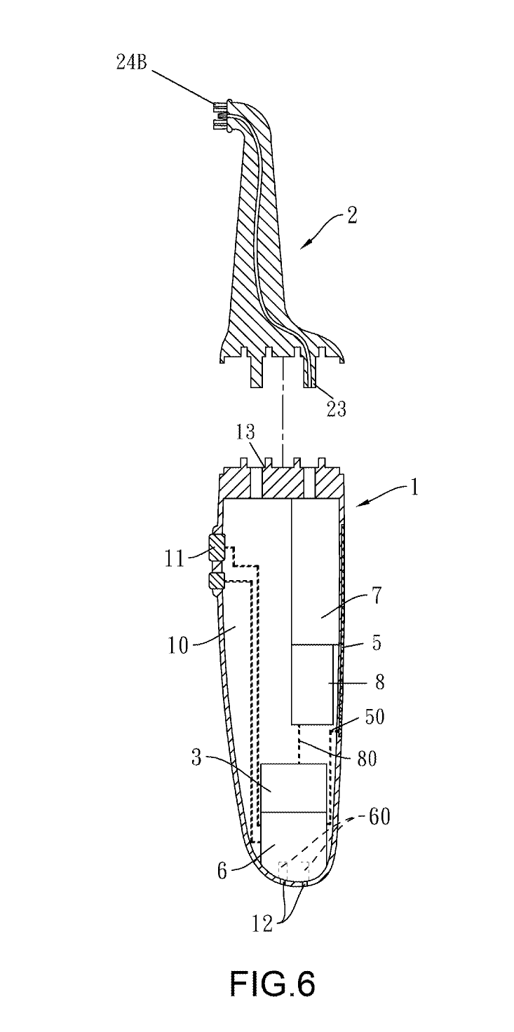

Referring to FIG. 6, the cleaning assembly 2 having a nozzle 24A shown in FIGS. 4 and 5 can be replaced by a concentric nozzle 24B if such need is desired.

While the invention has been described in terms of preferred embodiments, those skilled in the art will recognize that the invention can be practiced with modifications within the spirit and scope of the appended claims.

What is claimed is:

1. A dental hygiene device comprising:
a hollow handle including an on/off switch disposed an outer surface;
a cleaning assembly including a head, a cleaning unit rotatably disposed on the head, and a neck extending out of the head and configured to releasably secure to the handle;
a solar module disposed on the outer surface of the handle and configured to generate electrical power in response to light;
a rechargeable battery disposed in the handle and configured to store the electrical power wherein the rechargeable battery is electrically connected to the on/off switch;
a drive source disposed in the handle and electrically connected to the rechargeable battery; and
a rotation member disposed in the handle and electrically connected to the drive source;
wherein the cleaning unit is configured to rotate in response to an activation of the rotation member.

2. The solar powered dental hygiene device of claim 1, wherein the cleaning unit is a plurality of bristles.

3. The solar powered dental hygiene device of claim 1, wherein the cleaning unit is an interdental brush.

4. The solar powered dental hygiene device of claim 1, wherein the handle further comprising two through holes at a first end, the rechargeable battery comprises two sockets aligned with the through holes.

5. A dental hygiene device comprising:
a hollow handle including an on/off switch disposed an outer surface;
a cleaning assembly including a head, a cleaning unit disposed on the head, a neck extending out of the head and configured to releasably secure to the handle, and a tube through the neck to connect to the cleaning unit;
a solar module disposed on the outer surface of the handle and configured to generate electrical power in response to light;
a rechargeable battery disposed in the handle and configured to store the electrical power wherein the rechargeable battery is electrically connected to the on/off switch;
a drive source disposed in the handle and electrically connected to the rechargeable battery;
a reservoir disposed in the handle; and
a pump disposed in the handle;
wherein the pump is configure to move water from the reservoir to the cleaning unit through the tube in response to an activation of the drive source.

6. The solar powered dental hygiene device of claim 5, wherein the cleaning unit is a plurality of bristles.

7. The solar powered dental hygiene device of claim 5, wherein the cleaning unit is an interdental brush.

8. The solar powered dental hygiene device of claim 5, wherein the cleaning unit is a nozzle.

9. The solar powered dental hygiene device of claim 5, wherein the cleaning unit is a concentric nozzle.

10. The solar powered dental hygiene device of claim 5, wherein the handle further comprising two through holes at a first end, the rechargeable battery comprises two sockets aligned with the through holes.
